(19) United States
(12) Patent Application Publication
(10) Pub. No.: US 2025/0251054 A1
(43) Pub. Date: Aug. 7, 2025

(54) FLUID CONTROL VALVE WITH REPLACEABLE TRIM CARTRIDGE

(71) Applicant: Control Components, Inc., Rancho Santa Margarita, CA (US)

(72) Inventors: Daniel A. Watson, Rancho Santa Margarita, CA (US); Stephen Freitas, Rancho Santa Margarita, CA (US); Raymond Newton, Rancho Santa Margarita, CA (US); Shane Gillette, Rancho Santa Margarita, CA (US)

(21) Appl. No.: 19/043,024

(22) Filed: Jan. 31, 2025

Related U.S. Application Data
(60) Provisional application No. 63/549,949, filed on Feb. 5, 2024.

(51) Int. Cl. F16K 27/02; F16K 1/44; F16K 31/383

(52) U.S. Cl. CPC F16K 27/02; F16K 1/443; F16K 31/383

(57) ABSTRACT

A fluid control valve includes a housing defining inlet and outlet passages and an opening in communication with the passages, with the opening extending along a main axis. A replaceable trim cartridge is configured to be removably insertable into the opening along the main axis. The replaceable trim cartridge includes a cage defining a piston chamber, a cage inlet, a cage outlet, and an internal flow control configuration extending between the cage inlet and the cage outlet. The trim cartridge further includes a piston head movable within the piston chamber. A plug is coupled to the piston head and includes an external flow control configuration. The plug is moveable within the cage between a closed position and an open position, with at least a portion of the plug being in contact with the cage when the plug is in the closed position to restriction fluid flow through the cage.

### CROSS-REFERENCE TO RELATED APPLICATIONS

This application claims the benefit of U.S. Provisional Application Ser. No. 63/549,949, filed Feb. 5, 2024, the contents of which are expressly incorporated herein by reference.

### STATEMENT RE: FEDERALLY SPONSORED RESEARCH/DEVELOPMENT

Not Applicable

### BACKGROUND

### 1. Technical Field

The present disclosure relates generally to a fluid valve, and more specifically to a valve having a housing and a replaceable trim cartridge removably insertable into the housing to facilitate replacement of components experiencing wear.

### 2. Description of the Related Art

Linear fluid control valve assemblies are known, with an exemplary prior art, linear control valve 10 being depicted in FIG. 1. The valve 10 includes a housing 12 having an inlet flow passage 14, an outlet flow passage 16, and a valve seat 18 between the inlet flow passage 14 and the outlet flow passage 16. The valve seat 18 defines a seat opening that allows for fluid flow between the inlet flow passage 14 and the outlet flow passage 16. In more detail, the valve seat 18 includes an outlet surface 20, an inlet surface 22 and an opening surface 24 extending between the inlet surface 22 and the outlet surface 20. An inlet edge may be defined at the intersection between the inlet surface 22 and the opening surface 24, and an outlet edge may be defined between the intersection between the outlet surface 20 and the opening surface 24.

The valve 10 may also include a piston assembly including a piston head 26, a shaft 30, and a plug body 32 that is movable within the housing 12 between an open position and the closed position. In the open position, the plug body 32 is spaced from the inlet surface 22 to allow fluid to flow from the inlet flow passage 14, through the seat opening, and into the outlet flow passage 16. In the closed position, the plug body 32 is in contact with the inlet edge to block fluid flow from the inlet flow passage 14 through the seat opening. Thus, when the plug body 32 is in the open position, fluid may flow through the valve 10, and when the plug body 32 is in the closed position, fluid may be restricted from flowing through the valve 10.

Many linear control valve assemblies are used to control high-pressure fluids. A common issue that arises during use of conventional linear control valve assemblies over time is that the high pressure, temperature and/or make-up of the fluid may cause wear of certain surfaces or edges within the valve. Such wear may be particularly susceptible, and problematic, in the areas in and around the valve seat 18. If one or both of the inflow edge and the outflow edge experience high levels of wear, the valve seat 18 may not function properly, in which case, fluid flow may not be sufficiently restricted when the piston assembly is in the closed position. If the valve seat 18 does not function properly, the valve 10 may require replacement, which may be a tedious and costly endeavor. Oftentimes, replacement of the worn surfaces requires removal of the entire valve housing 12 and replacement with an entirely new valve housing 12. The location of the valve along with the configuration of the valve may create difficulties when trying to replace the valve.

Accordingly, there is a need in the art for a flow control valve configured to mitigate susceptibility to costly and tedious repairs of worn internal surfaces. Various aspects of the present disclosure address this particular need, as will be discussed in more detail below.

### BRIEF SUMMARY

According to one embodiment of the present disclosure, there is provided a fluid control valve comprising a housing defining a fluid inlet passage and a fluid outlet passage. The housing additionally defines an opening in communication with the fluid inlet passage and the fluid outlet passage, with the opening extending along a main axis. A replaceable trim cartridge is configured to be removably insertable into the opening of the housing along the main axis. The replaceable trim cartridge includes a cage defining a piston chamber, a cage inlet, a cage outlet, and an internal flow control configuration extending between the cage inlet and the cage outlet. The trim cartridge further includes a piston head movable within the piston chamber. A plug is coupled to the piston head and includes an external flow control configuration. The plug is moveable within the cage between a closed position and an open position, with at least a portion of the plug being in contact with the cage when the plug is in the closed position to restriction fluid flow through the cage.

The housing may include a main body and a valve bonnet detachable from the main body. The valve bonnet may be configured to enclose the replaceable trim cartridge within the main body when the replaceable trim cartridge is received within the main body and the valve bonnet is attached to the main body. The replaceable trim cartridge may be exposed when the valve bonnet is removed from the main body.

The replaceable trim cartridge may define a trim maximum outer diameter and the housing opening defines an opening outer diameter greater than the trim maximum outer diameter.

The housing may include a support surface upon which the replaceable trim cartridge is supported. The support surface may extend about the main axis and may be perpendicular to the main axis.

The replaceable trim cartridge may extend along a cartridge axis. The internal flow control configuration of the cage may include a plurality of cage projections extending radially inward toward the cartridge axis, and the external flow control configuration of the plug includes a plurality of plug projections extending radially outward away from the cartridge axis. Each plug projection may include an angled surface extending at an angle to the cartridge axis. Adjacent ones of the plurality of plug projections may be separated by an extension surface extending parallel to the cartridge axis.

The housing may include a boss extending from a lower portion of the housing opposite the plug when the replaceable trim cartridge is inserted into the housing. The plug may include a recess configured to receive the boss to facilitate desired alignment of the replaceable trim cartridge relative to the housing. A spring may extend around the boss and contact the plug.

According to another embodiment, there is provided a replaceable trim cartridge for removable use in a valve housing. The valve housing defines a fluid inlet passage, a fluid outlet passage and an opening in communication with the fluid inlet passage and the fluid outlet passage, with the opening extending along a main axis. The replaceable trim cartridge includes a cage defining a piston chamber, a cage inlet, a cage outlet and an internal flow control configuration extending between the cage inlet and the cage outlet. A piston head is movable within the piston chamber. A plug is coupled to the piston head and is moveable within the cage between a closed position and an open position. At least a portion of the plug is in contact with the cage when the plug is in the closed position to restriction fluid flow through the cage. The cage, the piston head, and the plug are collectively configured to enable selective insertion of the replaceable trim cartridge into the opening of the housing to enable fluid control within the housing, and removal of the replaceable trim cartridge from the opening of the housing.

The present disclosure will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is cross sectional view of an exemplary prior art flow control valve;

FIG. 2 is a partial, cross-sectional view of a fluid control valve having a replaceable trim cartridge;

FIG. 3 is a front view of the fluid control valve depicted in FIG. 2;

FIG. 4 is cross-sectional view of the fluid control valve depicted in FIG. 3;

FIG. 5 is a partial upper perspective view of the trim cartridge;

FIG. 6 is a side cross-sectional view of the trim cartridge;

FIG. 7 is a partial, cross-sectional view of a second embodiment of a fluid control valve having a replaceable trim cartridge;

FIG. 8 is a partial, cross-sectional view of a third embodiment of a fluid control valve having a replaceable trim cartridge;

FIG. 9 is a schematic view depicting fluid flow through the trim cartridge;

FIG. 10 is a partial, cross-sectional view of a fourth embodiment of a fluid control valve having a replaceable trim cartridge;

FIG. 11 is a front view of a fifth embodiment of a fluid control valve having a replaceable trim cartridge;

FIG. 12 is a cross-sectional view of the fluid control valve depicted in FIG. 11; and

FIG. 13 is a top view of the fluid control valve depicted in FIG. 11.

Common reference numerals are used throughout the drawings and the detailed description to indicate the same elements.

### DETAILED DESCRIPTION

The detailed description set forth below in connection with the appended drawings is intended as a description of certain embodiments of a flow control valve and is not intended to represent the only forms that may be developed or utilized. The description sets forth the various structure and/or functions in connection with the illustrated embodiments, but it is to be understood, however, that the same or equivalent structure and/or functions may be accomplished by different embodiments that are also intended to be encompassed within the scope of the present disclosure. It is further understood that the use of relational terms such as first and second, and the like are used solely to distinguish one entity from another without necessarily requiring or implying any actual such relationship or order between such entities.

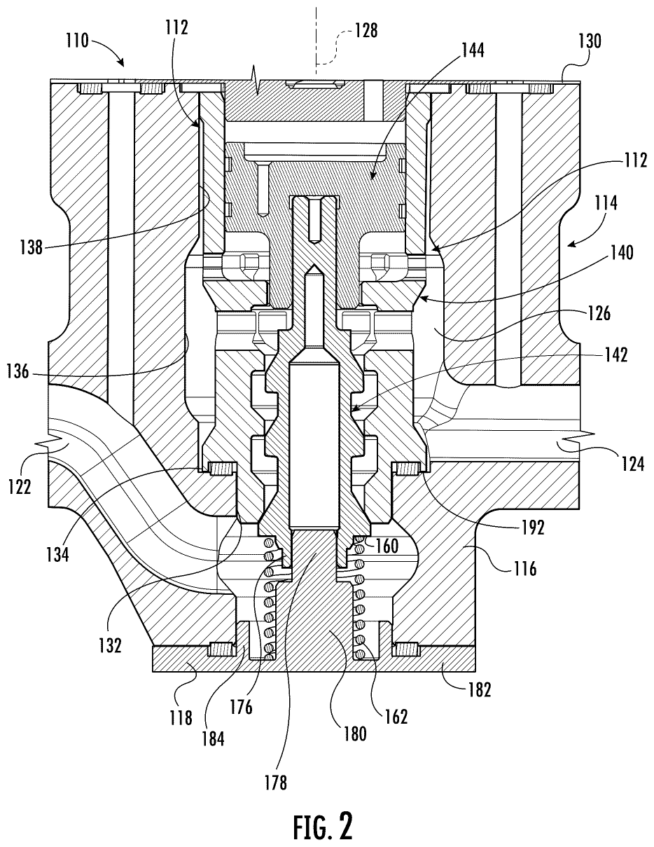

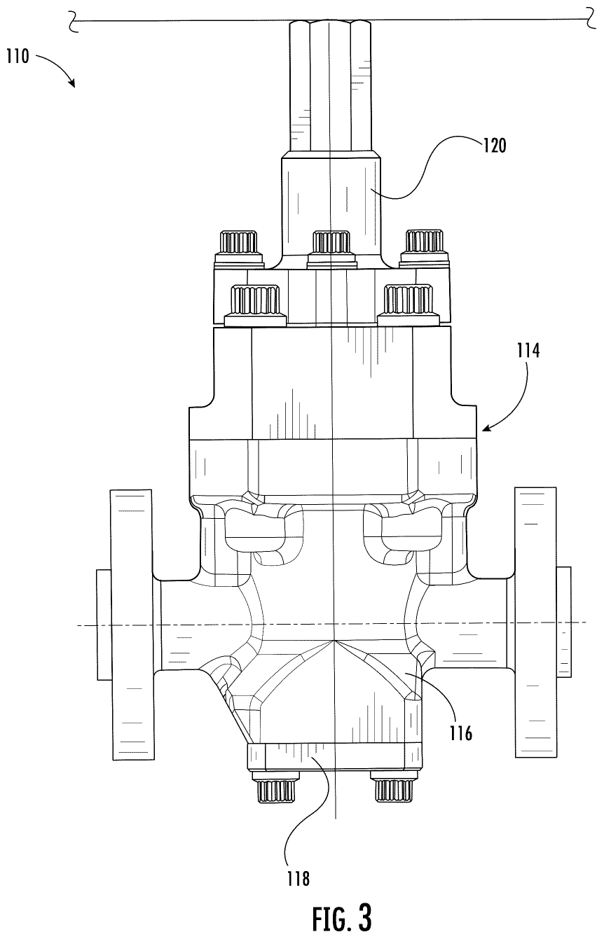

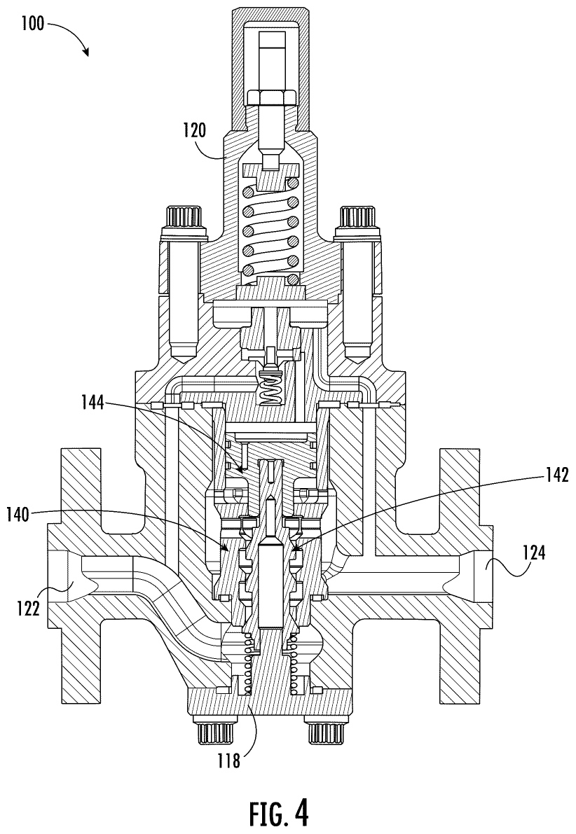

Referring now to the drawings, wherein the showings are for purposes of illustrating preferred embodiments of the present disclosure, and are not for purposes of limiting the same, there is depicted a fluid control valve 110. FIG. 2 depicts a partial, schematic, cross-sectional view of the fluid control valve 110, while FIG. 3 is a front view of the fluid control valve 110, and FIG. 4 is a complete cross-sectional view of the fluid control valve 110. Various aspects of the present disclosure relate to a replaceable trim cartridge 112 that is removably insertable into a valve housing 114. The replaceable trim cartridge 112 is configured to control fluid flow through the valve 110 between open flow conditions and closed flow conditions. Over time, one or more surfaces within the trim cartridge 112 may degrade to the point which causes reduced performance. When the fluid control performance of the trim cartridge 112 falls below a desired level, the trim cartridge 112 may be easily removed from the valve housing 114 and replaced with a new trim cartridge 112. Once the new trim cartridge 112 is installed, the fluid control performance of the valve 110 should return to optimal levels.

By utilizing a replaceable trim cartridge 112, the critical areas that have degraded, e.g., degraded areas around the valve seat, may be easily accessed and replaced without requiring replacement of the entire valve 110. As such, the valve housing 114 may be reusable with several trim cartridges 112 over time. Thus, once degradation of the valve 110 is detected, action can be quickly and easily taken to replace the degraded areas with new replacement components which reduces the time the valve 110 is offline.

In more detail, the housing 114 includes a main body 116, a lower body 118, and a valve bonnet 120. The main body 116 defines defining an inlet flow passage 122, an outlet flow passage 124, and a gallery 126 between the inlet flow passage 122 and the outlet flow passage 124. In the perspectives depicted in FIGS. 2-4, fluid flows in a generally left-to-right direction as fluid flows from the inlet flow passage 122 toward the outlet flow passage 124. However, it is understood that the fluid flow may be reversed, such that fluid flows from the outlet flow passage 124 to the inlet flow passage 122.

The main body 116 includes an opening extending along a main axis 128 from an upper surface 130, with the opening including the gallery 126, as well as a gallery inlet and a cartridge access portion, with the gallery inlet and cartridge access portion being on opposite sides of the gallery 126. The surfaces defining the opening which extends from the gallery inlet to the upper surface 130 will now be described. The gallery inlet is defined by a gallery inlet wall 132 which may extend around the main axis 128. The gallery inlet wall 132 may transition to a gallery end wall 134 (e.g., support surface). In one embodiment, the gallery inlet wall 132 and the gallery end wall 134 may be perpendicular to each other, with the gallery end wall 134 extending radially outward from the gallery inlet wall 132. The gallery end wall 134 may form a shoulder against which the trim cartridge 112 may rest or be supported upon insertion of the trim cartridge 112 into the main body 116, as will be described in more detail below. The gallery end wall 134 may extend around the main axis 128.

The gallery end wall 134 transitions into a gallery main wall 136, which extends from the gallery end wall 134 in a direction along the main axis 128. In this regard, it is understood that the gallery main wall 136 may include portions which protrude radially outwardly relative to other portions of the gallery main wall 136 to provide increased volume to the gallery 126. The gallery main wall 136 transitions to cartridge access wall 138, which extends around the main axis 128. The cartridge access wall 138 defines the cartridge access portion of the opening and provides some distance between the gallery 126 and the upper surface 130 of the main body 116.

It is contemplated that the main body 116 and/or the lower body 118 may include auxiliary flow passages formed therein to facilitate implementation of various functionalities, e.g., pressure relief, valve piloting, etc., without departing from the spirit and scope of the present disclosure.

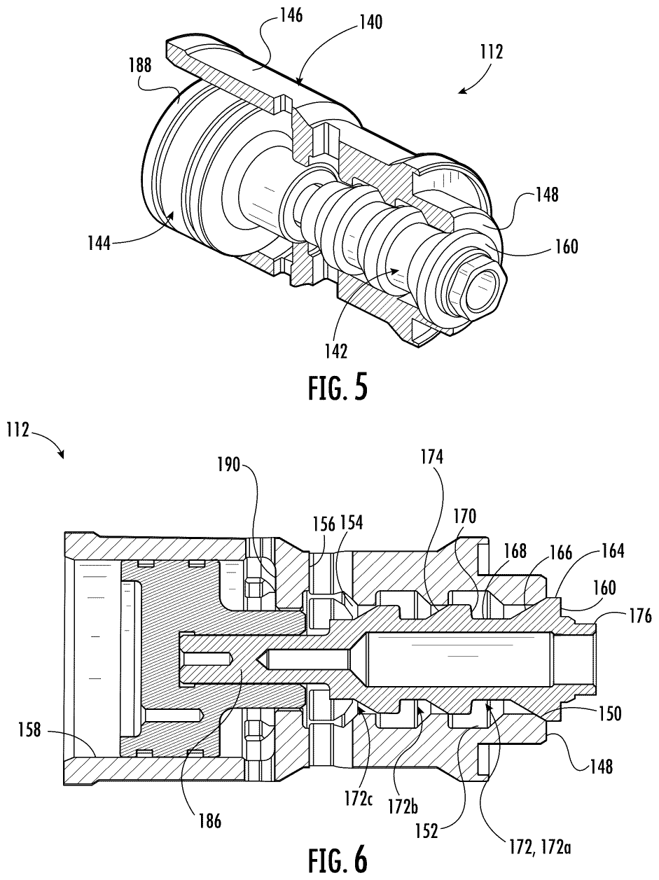

Turning now to the details of the trim cartridge 112, FIGS. 2 and 4 depict the trim cartridge 112 installed within the main body 116, while FIGS. 5 and 6 depict the trim cartridge 112 removed from the main body 116. According to one embodiment, the trim cartridge 112 includes a cage 140, a plug 142 and a piston head 144, each of which extend along a cartridge longitudinal axis that is coaxial with the main axis 128 of the main body 116 when the trim cartridge 112 is installed within the main body 116. The cage 140 defines an outer surface 146 configured to interface with the main body 116, several inner surfaces configured to interface with both the plug 142 and the piston head 144, and a pair of opposing end surfaces. A first end surface 148 extends around a cage inlet opening. The first end surface 148 may transition to a cage seating surface 150, which may be angled relative to the first end surface 148, and which may be configured to interface with the plug 142, as will be described in more detail below. The cage seating surface 150 may transition to a cage flow control surface 152 having a prescribed contour that may cooperate with the contour of the plug 142 to create desired flow characteristics in the fluid flowing through the trim cartridge 112. In the exemplary embodiment, the cage flow control surface 152 defines a plurality of radially-inwardly protruding ribs, and a plurality of radially-outwardly protruding recesses which partially define a tortuous flow path.

The cage 140 may additionally include a gallery inner surface 154 defining a cage gallery, and at least one cage outlet surface 156 defining a cage outlet passage.

In addition to the inner surfaces of the cage 140 described above, which interface with the plug 142, the cage 140 includes an inner surface 158 which defines a chamber within which the piston head 144 may reside. The chamber may be sized to allow the piston head 144 to translate therein during operation of the valve 110. The cage 140 may include one or more chamber piloting ports extending from the chamber and through the outer wall of the cage 140. The piloting ports may allow fluid to flow to the chamber or from the chamber to control position of the piston head 144 within the chamber. It is contemplated that the cage 140 may be one integral structure, or alternatively, multiple structures that may be attached to each other. For instance, a first structure may interface with the piston head 144 and a second structure may interface with the plug 142.

The plug 142 is coupled to the piston head 144 and is configured to move with the piston head 144 relative to the cage 140. The plug 142 includes a flow control end portion including a plug end surface 160, which may be configured to interface with a spring 162. The plug end surface 160 may transition to a plug outer sidewall surface 164, which may define a maximum outer diameter/periphery of the plug 142. The plug outer sidewall surface 164 may transition to a plug seating surface 166, which may be configured to interface with the cage seating surface 150. In this regard, the angle of the plug seating surface 166 relative to the main axis 128 may be similar to the angle of the cage seating surface 150 relative to the main axis 128 to allow for face-to-face contact to restrict fluid flow therebetween when the plug 142 is in the closed position. The plug seating surface 166 may transition to a plug axial surface 168 which may extend generally parallel to the main axis 128. The plug axial surface 168 may transition to a plug radial surface 170, which may extend radially outward from the plug axial surface 168. In one embodiment, the plug radial surface 170 is generally perpendicular to the plug axial surface 168, although other angular orientations between the plug radial surface 170 and plug axial surface 168 are contemplated without departing from the spirit and scope of the present disclosure.

The plug seating surface 166, plug axial surface 168 and plug radial surface 170 may collectively define a notch 172 formed on the plug 142. The notch 172 may be configured to induce desired flow characteristics of a fluid flowing over the plug 142.

The above-described configuration of the plug 142 may be generally repeated in an axial direction to form one or more additional notches 172, with each notch 172 being spaced by a plug radial surface 170. In the exemplary embodiment, the plug 142 includes a distal notch 172a, an intermediate notch 172b, and a partial, proximal notch 172c. The surfaces defining the distal notch 172c have been described in more detail above. The intermediate notch 172b is defined by an angled surface 174, which is similar to the plug seating surface 166, although shorter in length. The intermediate notch 172b may also include a plug axial surface 168 and a plug radial surface 170. The proximal notch 172c may also include an angled surface 174 and a plug axial surface 168 and may be devoid of a plug radial surface 170.

The number of notches 172, particularly the number of intermediate notches 172b, may vary without departing from the spirit and scope of the present disclosure. For more information regarding the configuration of the plug 142, please refer to U.S. Pat. No. 7,959,127, entitled AXIAL TRIM FOR DIRTY SERVICE VALVE, the contents of which are expressly incorporated herein by reference.

The plug 142 may be configured to interface with the lower body 118 of housing 114. In this regard, the plug 142 may include an axially extending sleeve 176 configured to receive a boss 178 formed on the lower body 118. The boss 178 on the lower body 118 may be a protruding feature extending from a lower body base 180, which in turn, extends from a lower body end plate 182 adapted to be connected to the main body 116 of the housing 114. The main body 116 may include a lower opening, which is axially aligned with the main axis 128 and the gallery, to facilitate insertion of the lower body 118 into the main body 116. The lower body 118 may include a stabilizing sidewall 184 that extends from the end plate 182 and is adapted to engage with an inner surface of the main body 116 to stabilize and secure the lower body 118 relative to the main body 116. Spring 162 may extend between the lower body 118 and the plug 142 to impart a biasing force on the plug 142. In the embodiment depicted in FIG. 2, the spring 162 extends between end surface 160 of the plug 142 to an inner surface of the lower body end plate 182, with the spring 162 extending around the boss 178 and the lower body base 180. The spring 162 may bias the plug 142 toward its closed position, i.e., bias the plug seating surface 166 against the cage seating surface 150. Thus, to transition the plug 142 from the closed position toward the open position, a force may be applied to the plug 142 which overcomes the biasing force of the spring 162.

The portion of the plug 142 engaged with the piston head 144 may be a piston engagement end portion and may include an elongate shaft 186 that may be received into a corresponding channel or recess formed on the piston head 144. The piston head 144 may include an outer surface 188 that interfaces with the inner surface 158 of the cage 140, with the outer surface 188 of the piston head 144 and the inner surface 158 of the cage 140 being configured to create a substantially fluid-tight fit therebetween. In this regard, one or more seals may be coupled to the outer surface 188 of the piston head 144 to facilitate creation of the fluid-tight fit.

During operation of the valve 110, the position of the plug 142 relative to the cage 140 may be regulated via control of the position of the piston head 144. When the plug 142 is in the closed position, the plug seating surface 166 is seated against the cage seating surface 150 to prevent fluid flow from inlet flow passage 122 to the outlet flow passage 124 through the cage opening. Furthermore, the plug angled surfaces 174 may be in contact with the cage ribs, which may fluidly isolate the internal voids within the trim cartridge 112, i.e., the voids collectively defined by a cage recess and a corresponding notch 172, from each other.

To move the plug 142 from the closed position toward the open position, a force (e.g., a piloting fluid force) is applied to the piston head 144 to overcome the biasing force of the spring 162. This action results in the plug seating surface 166 moving away from the cage seating surface 150, thereby allowing fluid to flow from the inlet flow passage 122 to the outlet flow passage 124 through the cage opening. The degree to which the plug 142 is open may be dependent upon the distance between the plug seating surface 166 and the cage seating surface 150. When the plug seating surface 166 is spaced further from the cage seating surface 150, the plug 142 may be opened by a greater degree than when the plug seating surface 166 is closer to the cage seating surface 166.

To close the plug 142, the force applied to the piston head 144 is reduced to allow the biasing force of the spring 162 to move the plug seating surface 166 into contact with the cage seating surface 150, which effectively closes the cage opening to prevent fluid flow from the inlet flow passage 122 to the outlet flow passage 124 through the cage opening.

As the valve 110 is used over time, the surfaces of the trim cartridge 112 may begin to degrade. For instance, the plug seating surface 166 and/or the valve seating surface 150 may wear, which may reduce the ability of the plug 142 to achieve a completely closed configuration. Furthermore, portions of the internal surfaces of the cage 140, as well as outer surfaces of the plug 142 may experience wear, which may reduce the effectiveness of facilitating desired fluid flow characteristics. When degradation of the trim cartridge 112 is detected, such as by reduced performance, or visual inspection, the trim cartridge 112 may be removed from the housing 114 and replaced with a new trim cartridge 112. Access to the cartridge 112 may be facilitated by disassembly of a portion of the housing 114 to expose a portion of the trim cartridge 112. In one embodiment, the valve bonnet 120 may be removed from the main body 116 to expose the trim cartridge 112. Once exposed, the trim cartridge 112 may be moved out of the housing 114. It is contemplated that portions of the trim cartridge 112, such as an inner surface of the cage 140, may have one or more recesses, or other features, which may be engaged by a tool to more easily remove the trim cartridge 112 from the main body 116. Along these lines, it is contemplated that the trim cartridge 112 may be configured to be removed from the housing 114 in a prescribed removal direction. In the exemplary embodiment, the trim cartridge 112 is removed from the main body 116 in a direction toward the upper surface 130 of the main body 116, and away from the where the lower plate 118 connects to the main body 116. In some instances, the lower plate 118 may be removed to allow for application of a force on the trim cartridge 112 to aid in removing of the trim cartridge 112 from the main body 116. The main body 116 may be configured such that no surface of the main body 116 may impede removal of the trim cartridge 112 in the prescribed removal direction. Furthermore, the piston head 144 and the plug 142 may be operatively coupled to the cage 140 such that when the cage 140 is removed from the main body 116, the piston head 144 and plug 142 also are removed with the cage 140. For instance, when the cage 140 is moved from the main body 116, the piston head 144 may move relative to the cage 140 until the piston head 144 is seated against a support surface 190 of the cage 140. Once seated against the support surface 190, the piston head 144 moves with the cage 140 as the cage 140 is moved in the prescribed removal direction. The plug 142 may be coupled to the piston head 144 in a manner such that the plug 142 moves with the piston head 144. Thus, the trim cartridge 112 may be configured to allow for removal of the entire cartridge 112 by acting solely on the cage 140, without requiring separate action on the plug 142 or piston head 144

Once the worn cartridge 112 is removed, a new cartridge 112 may be inserted into the main body 116. In particular, the new cartridge 112 may be inserted into the main body 112 in a prescribed insertion direction that is opposite the prescribed removal direction. The new cartridge 112 may be inserted into the main body 116 along the main axis 128, leading with the exposed end of the plug 142. As the cartridge 112 is inserted, the fluid control end portion of the cage 140 is advanced into the main body 116 until surface 192 of cage 140 is adjacent gallery end wall 134 of the main body 116. A seal may be placed between surface 192 and gallery end wall 134 to prevent undesirable migration of fluid therebetween. It is contemplated that the housing 114 and cartridge 112 may have complementary features that register the cartridge 112 relative to the housing 114 in a particular orientation. For instance, the housing 114 and trim cartridge 112 may include complementary fin/groove structures which may enable placement of the trim cartridge 112 within the housing 114 in a particular orientation.

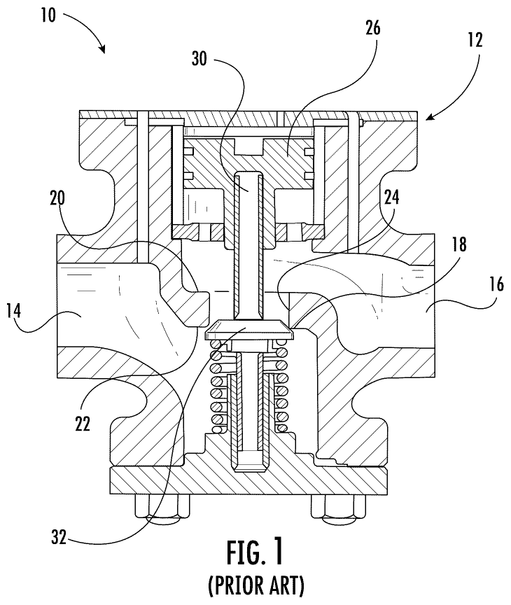

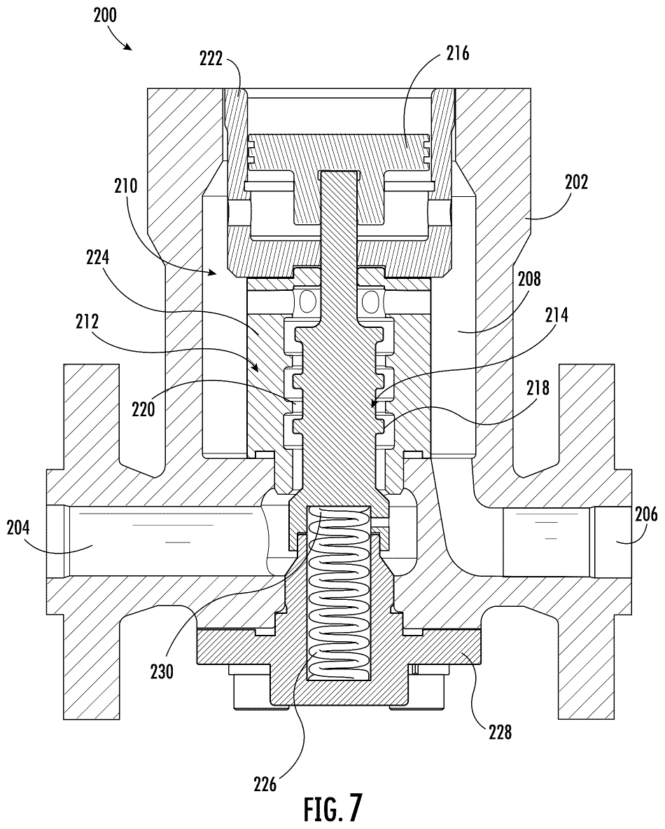

Referring now to FIGS. 7-13, there is depicted several views of various flow control valves, each of which include a removable valve trim cartridge, although, each Figure shows at least one minor variation or additional feature not shown in FIGS. 1-6 or described above. The discussion related to FIGS. 7-13 focuses on unique features illustrated therein.

FIG. 7 depicts another embodiment of the control valve 200 having main housing 202 including an inlet flow passage 204, an outlet flow passage 206 and a gallery 208 therebetween. A trim cartridge 210 is received within an opening formed in the main housing 202, with the trim cartridge 210 including a cage 212, a plug 214, and a piston head 216. A unique feature of the trim cartridge 210 in FIG. 7 is the flow control configuration collectively defined by the cage 212 and the plug 214. In more detail, the plug 214 includes a plurality of outwardly protruding ribs 218, with each rib 218 having generally square corners. The cage 212 includes a plurality of inwardly protruding ribs 220 (i.e., inward toward a central axis), with each rib 220 having generally square corners. When the plug 214 is in a closed position, the ribs 218 on the plug 214 may be adjacent to, or in contact with, corresponding ribs 220 on the cage 212. As the plug 214 moves from the closed position toward the open position, the ribs 218 on the plug 214 may move away from the corresponding ribs 220 on the cage 212.

The cage 212 depicted in FIG. 7 includes a piston head chamber body 222 and a flow control body 224. The piston head chamber body 222 may define the chamber within which the piston head 216 may move, and may be separate from the flow control body 224. The flow control body 224 may be detachably connectable to the piston head chamber body 222 via mechanical fasteners, such as screws, bolts, and the like. The ability to detach the flow control body 224 from the piston head chamber body 222 may allow for use of different flow control bodies 224 with a single piston head chamber body 222. Different flow control bodies 224 may be used to replace a worn flow control body 224, or to utilize a flow control body 224 having a different flow control configuration.

The valve 200 depicted in FIG. 7 also includes a spring 226 that is received within a cavity formed in a lower body 228, with the spring 226 interfacing with an internally recessed surface 230 on the plug 214. The spring 226 biases the plug 214 toward the closed position. With the spring 226 in the cavity, the spring 226 may be isolated from the fluid flow.

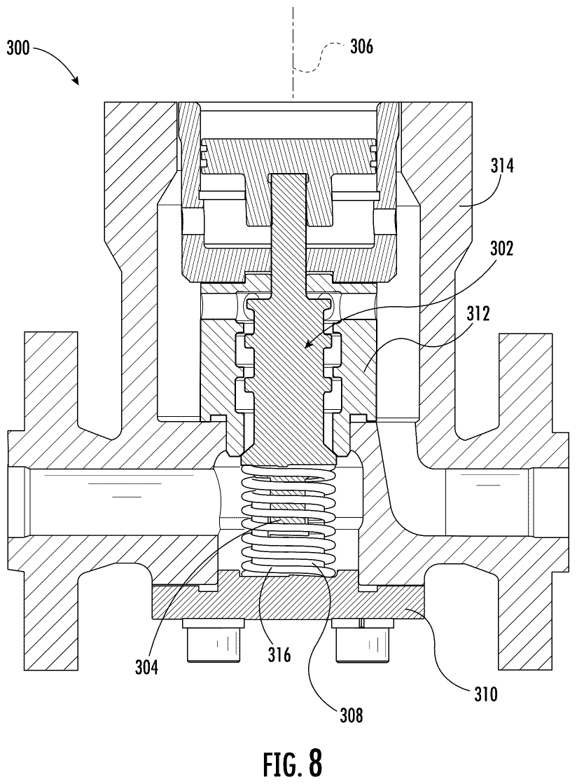

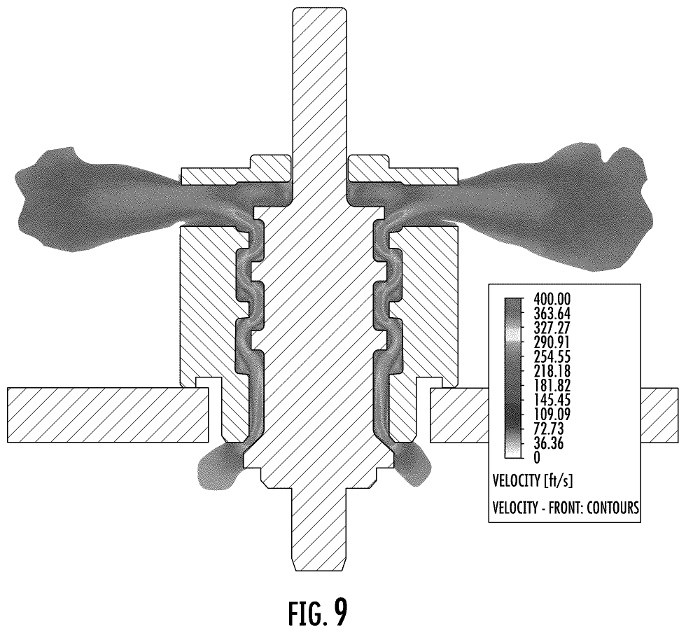

FIG. 8 depicts another variation of a valve 300 including a plug 302 having a projecting distal finger 304 extending along a longitudinal axis 306 of the plug 302. The distal finger 304 may be received within a recess formed in a projecting sleeve 308 on a lower body 310 to facilitate centering of the plug 302 relative to a cage 312 and main body 314. A spring 316 may extend around the projecting sleeve 308 and between an end surface of the plug 302 and an inner surface of the lower body 310.

FIG. 9 is a schematic view illustrating flow velocity through the cage of the valve depicted in FIG. 8 when the plug is in an open position.

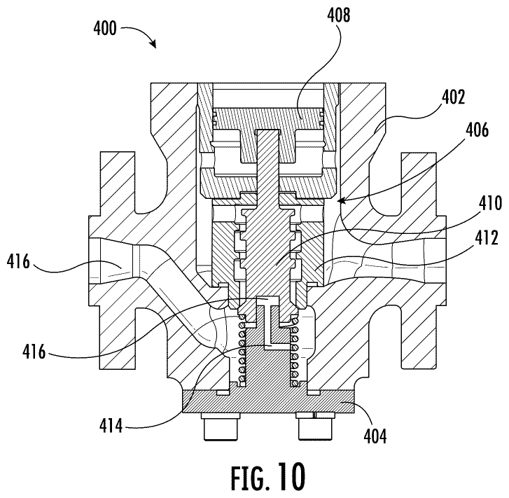

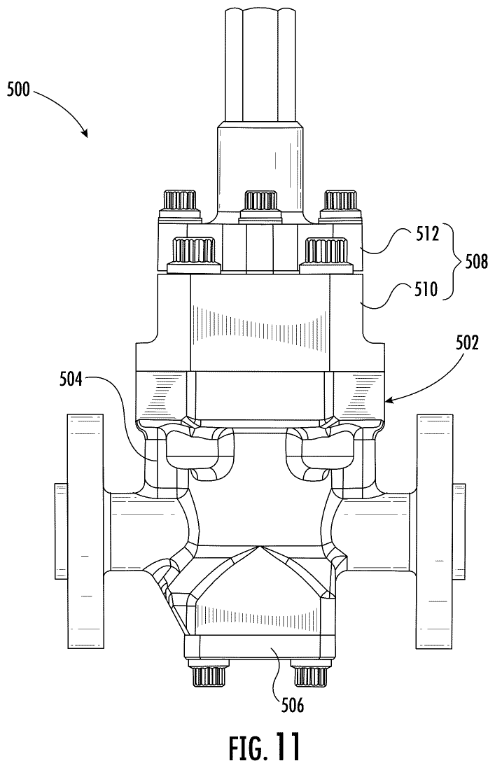

FIG. 10 depicts a valve 400 generally including a main body 402, a lower body 404, and a trim cartridge 406 including a piston head 408, a plug 410, and a cage 412. The embodiment depicted in FIG. 10 additionally includes a flow port 414 formed in a protruding feature on the lower body 404, with one end of the port 414 being in communication with a chamber 416 defined by the plug 410 and the lower body 404. Another end of the flow port 414 is in communication with an inlet flow passage 416. Thus, the flow port 414 may allow for pressurization of the chamber 416, which may apply a biasing force on the plug 410 toward the closed position.

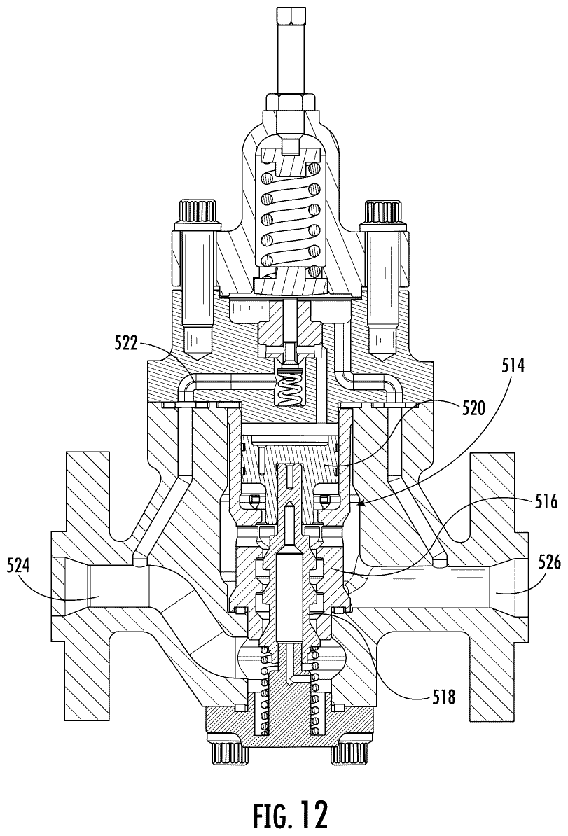

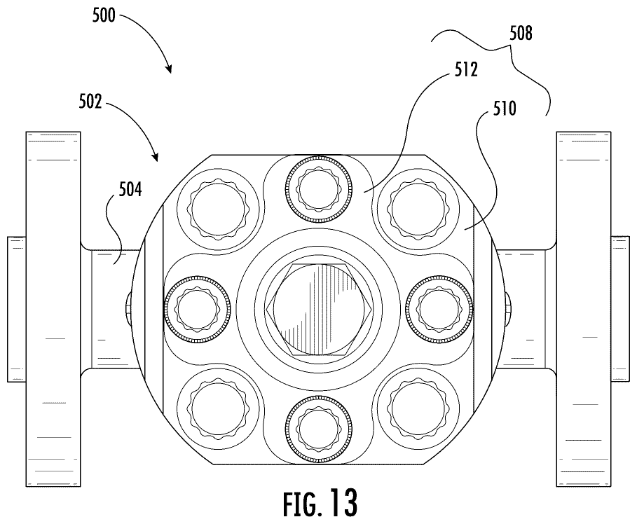

FIGS. 11-13 depict another embodiment of a control valve 500, with FIG. 11 depicting a front view of the valve 500, FIG. 12 depicting a cross-sectional view of the valve 500, and FIG. 13 depicting a top view of the valve 500. The valve 500 includes a housing 502 including a main body 504, a lower body 506, and a valve bonnet 508 including a lower bonnet body 510 and an upper bonnet body 512. The valve 500 additionally includes a trim cartridge 514 including a cage 516, a plug 518 and a piston head 520. The trim cartridge 514 depicted in FIG. 12 is similar to the trim cartridge 112 of FIG. 2. A unique feature of the valve 500 of FIGS. 11-13 is the use of a valve bonnet 508 having lower and upper bonnet bodies 510, 512. The valve bonnet 508 may include a bypass fluid passage 522 that may be used as an auxiliary/pressure relief passage between the inflow passage 524 and the outflow passage 526. Furthermore, the bypass fluid passage 522 may be in communication with the piston head chamber to allow pressure from the bypass fluid passage 522 to function in a piloting capacity.

FIGS. 7-13 illustrate that a trim cartridge may be incorporated into almost any control valve, and that the configuration of the valve housing, or the particular configuration of the cage, plug, and piston head, are not limited to any particular configuration.

The particulars shown herein are by way of example only for purposes of illustrative discussion and are not presented in the cause of providing what is believed to be most useful and readily understood description of the principles and conceptual aspects of the various embodiments of the present disclosure. In this regard, no attempt is made to show any more detail than is necessary for a fundamental understanding of the different features of the various embodiments, the description taken with the drawings making apparent to those skilled in the art how these may be implemented in practice.

What is claimed is:

1. A fluid control valve comprising:
a housing defining a fluid inlet passage and a fluid outlet passage and an opening in communication with the fluid inlet passage and the fluid outlet passage, the opening extending along a main axis; and
a replaceable trim cartridge configured to be removably insertable into the opening of the housing along the main axis, the replaceable trim cartridge comprising:
a cage defining a piston chamber, a cage inlet, a cage outlet and an internal flow control configuration extending between the cage inlet and the cage outlet;
a piston head movable within the piston chamber; and
a plug coupled to the piston head and having an external flow control configuration, the plug being moveable within the cage between a closed position and an open position, at least a portion of the plug being in contact with the cage when the plug is in the closed position to restriction fluid flow through the cage.

2. The fluid control valve recited in claim 1, wherein the housing includes a main body and a valve bonnet detachable from the main body, the valve bonnet being configured to enclose the replaceable trim cartridge within the main body when the replaceable trim cartridge is received within the main body and the valve bonnet is attached to the main body, the replaceable trim cartridge being exposed when the valve bonnet is removed from the main body.

3. The fluid control valve recited in claim 1, wherein the replaceable trim cartridge defines a trim maximum outer diameter and the housing opening defines an opening outer diameter greater than the trim maximum outer diameter.

4. The fluid control valve recited in claim 1, wherein the housing includes a support surface upon which the replaceable trim cartridge is supported.

5. The fluid control valve recited in claim 4, wherein the support surface extends about the main axis.

6. The fluid control valve recited in claim 4, wherein the support surface is perpendicular to the main axis.

7. The fluid control valve recited in claim 1, wherein the replaceable trim cartridge extends along a cartridge axis, the internal flow control configuration of the cage includes a plurality of cage projections extending radially inward toward the cartridge axis, and the external flow control configuration of the plug includes a plurality of plug projections extending radially outward away from the cartridge axis.

8. The fluid control valve recited in claim 7, wherein each plug projection includes an angled surface extending at an angle to the cartridge axis, adjacent ones of the plurality of plug projections being separated by an extension surface extending parallel to the cartridge axis.

9. The fluid control valve recited in claim 1, wherein the housing includes a boss extending from a lower portion of the housing opposite the plug when the replaceable trim cartridge is inserted into the housing, the plug including a recess configured to receive the boss to facilitate desired alignment of the replaceable trim cartridge relative to the housing.

10. The flow control valve recited in claim 9, further comprising a spring extending around the boss and contacting the plug.

11. A fluid control valve comprising:
a housing defining a fluid inlet passage and a fluid outlet passage and an opening in communication with the fluid inlet passage and the fluid outlet passage, the opening extending along a main axis; and
a replaceable trim cartridge configured to be removably insertable into the opening of the housing along the main axis, the replaceable trim cartridge comprising:
a cage defining a piston chamber, a cage inlet, a cage outlet and an internal flow control configuration extending between the cage inlet and the cage outlet;
a piston head movable within the piston chamber; and
a plug coupled to the piston head and moveable within the cage between a closed position and an open position, at least a portion of the plug being in contact with the cage when the plug is in the closed position to restriction fluid flow through the cage.

12. The fluid control valve recited in claim 11, wherein the housing includes a main body and a valve bonnet detachable from the main body, the valve bonnet being configured to enclose the replaceable trim cartridge within the main body when the replaceable trim cartridge is received within the main body and the valve bonnet is attached to the main body, the replaceable trim cartridge being exposed when the valve bonnet is removed from the main body.

13. The fluid control valve recited in claim 11, wherein the replaceable trim cartridge defines a trim maximum outer diameter and the housing opening defines an opening outer diameter greater than the trim maximum outer diameter.

14. The fluid control valve recited in claim 11, wherein the housing includes a support surface upon which the replaceable trim cartridge is supported.

15. The fluid control valve recited in claim 14, wherein the support surface extends about the main axis.

16. The fluid control valve recited in claim 14, wherein the support surface is perpendicular to the main axis.

17. The fluid control valve recited in claim 11, wherein the housing includes a boss extending from a lower portion of the housing opposite the plug when the replaceable trim cartridge is inserted into the housing, the plug including a recess configured to receive the boss to facilitate desired alignment of the replaceable trim cartridge relative to the housing.

18. A replaceable trim cartridge for removable use in a valve housing, the valve housing defining a fluid inlet passage, a fluid outlet passage and an opening in communication with the fluid inlet passage and the fluid outlet passage, the opening extending along a main axis, the replaceable trim cartridge comprising:
a cage defining a piston chamber, a cage inlet, a cage outlet and an internal flow control configuration extending between the cage inlet and the cage outlet;
a piston head movable within the piston chamber; and
a plug coupled to the piston head and moveable within the cage between a closed position and an open position, at least a portion of the plug being in contact with the cage when the plug is in the closed position to restriction fluid flow through the cage;
the cage, the piston head, and the plug being collectively configured to enable selective insertion of the replaceable trim cartridge into the opening of the housing to enable fluid control within the housing, and removal of the replaceable trim cartridge from the opening of the housing.

19. The replaceable trim cartridge recited in claim 18, wherein the replaceable trim cartridge extends along a cartridge axis, the internal flow control configuration of the cage includes a plurality of cage projections extending radially inward toward the cartridge axis, and the external flow control configuration of the plug includes a plurality of plug projections extending radially outward away from the cartridge axis.

20. The replaceable trim cartridge recited in claim 18, wherein each plug projection includes an angled surface extending at an angle to the cartridge axis, adjacent ones of the plurality of plug projections being separated by an extension surface extending parallel to the cartridge axis.
